(19) United States
(12) Patent Application Publication
(10) Pub. No.: US 2010/0026933 A1
(43) Pub. Date: Feb. 4, 2010

(54) SECONDARY DISPLAY USING PDLC

(75) Inventors: Robert C. Daigle, Amston, CT (US); David G. Pires, Phoenix, AZ (US); Walter J. Paciorek, Phoenix, AZ (US)

Correspondence Address: CANTOR COLBURN, LLP, 20 Church Street, 22nd Floor, Hartford, CT, 06103, US

(73) Assignee: WORLD PROPERTIES INC., Lincolnwood, IL (US)

(21) Appl. No.: 12/519,316

(22) PCT Filed: Dec. 11, 2007
(86) PCT No.: PCT/US07/25310

§ 371 Date: Aug. 20, 2009

Related U.S. Application Data
(60) Provisional application No. 60/875,224, filed on Dec. 14, 2006.

(51) Int. Cl. G02F 1/13357

(52) U.S. Cl. 349/65

(57) ABSTRACT

A secondary display is provided on, in, or under the case of an electronic device at a location convenient for viewing. The secondary display includes PDLC and a backlight. The backlight is preferably either an electroluminescent panel or an array of light emitting die. In the latter case, a transflector is located between the light source and the PDLC.

### RELATED APPLICATION

Applicant claims the benefit of the filing date of Provisional Application No. 60/875,224, filed Dec. 14, 2006, and incorporated herein by reference.

### FIELD OF THE INVENTION

This invention relates to displays and, in particular, to a secondary display using polymer dispersed liquid crystal (PDLC) as the operative material.

### GLOSSARY

As used herein, a “display” is a device that provides information in visual form to a viewer. A keyboard is usually not a display because it does not convey information to the viewer. A keyboard is an input device, not an output device.

A “graphic” can be text, a symbol, an arbitrary shape, or some combination thereof. A graphic can be translucent, shaded, colored, a silhouette or outline, or some combination thereof.

An EL “panel” is a single substrate including one or more luminous areas, wherein each luminous area is an EL “lamp.” An EL panel can back-light plural capacitive switches but the lamps need not have a 1:1 correspondence with the switches.

A “thick film” EL lamp refers to one type of EL lamp and “thin film” EL lamp refers to a different type of EL lamp. The terms only broadly relate to actual thickness and actually identify distinct disciplines. A thin, thick film EL lamp is not a contradiction in terms and such a lamp is considerably thicker than a thin film EL lamp.

A “phosphor layer” is not restricted to a single phosphor and does not exclude cascading phosphors or dyes for color enhancement.

A “portable computer” includes lap top computers and smaller, handheld or personal electronic devices.

### BACKGROUND OF THE INVENTION

The essence of effective communication is that a message be received as intended. For a display, it is not sufficient merely to provide the information in a clutter and let the viewer sort things out. There may not be time for interpretation, e.g. in the cockpit of an airplane. Thus, there is a continuing need to improve the quality of displays for ease of understanding or increased intelligibility.

There are many technologies that have been used for implementing a display. One, liquid crystal displays, were limited initially to seven segments for displaying numerals, with relatively large segments. As the technology improved, not only could more information be crammed into the same area as before, color became available as well. To avoid plainness, icons were designed to convey information in the name of simplicity, universality, and cuteness. The result is that a modern display can be a forest of data, some symbolic, some literal, to which the user must acclimate, largely by ignoring some of it.

It has been found that some data is more intelligible when represented graphically, e.g. an analog clock face or a bar graph, rather than digitally as a plurality of numbers. The amount information contained in such graphic displays is relatively small, referred to herein as “low content” information, but is easily and rapidly understood.

In the last twenty years, a particular class of materials, known as polymer dispersed liquid crystals, has been developed for displays; e.g., see U.S. Pat. No. 4,435,047 (Fergason). Devices using these materials operate at 60-120 volts peak-to-peak, unlike earlier liquid crystal materials that operated at much lower voltages, and provide contrast without the need for polarizers. Sometimes referred to as “optical shutters,” polymer dispersed liquid crystals have applications outside the realm of displays.

An avionics display using PDLC is disclosed in U.S. Pat. No. 6,144,359 (Grave). U.S. Pat. No. 6,842,170 (Akins et al.) discloses a PDLC display combined with a touchscreen in a cellular telephone. The PDLC is part of a keypad, containing a mask layer with images of the buttons on a telephone (0-9, * and #) and other control buttons. A PDLC display combined with a touchscreen is also disclosed in the Aug. 2, 1999, issue of Design News, in an article entitled “Call 911-display.”

Arrays of LEDs are known in the art. For example, U.S. Pat. No. 4,047,075 (Schoberl) discloses an array of LEDs made by simply stacking a plurality of packaged LEDs in a small volume. Packaged LEDs occupy greater volume than a semiconductor die or chip within a package. U.S. Pat. No. 4,335,501 (Wickenden et al.) discloses an array of LED dice on a single semiconductor substrate.

The choice of a technology for a particular display is a balance of competing interests, not the least of which is cost. In the case of cellular telephones, the choice is often made based on the presumption that the user will be indoors or at least not in direct sunlight when the telephone is used. In other words, the content of the display all but vanishes in bright light because the display relies on backlighting for visibility. (Strictly speaking, a liquid crystal display relies on backlighting but the backlighting is provided by a reflective layer, not a low power light source. Thus, the backlighting increases or decreases with ambient light and the content of the display remains visible.)

Although the content of a display may vanish, some information can be of immediate and continuing interest to a user, e.g. battery life. Thus, it is desirable for some information to be continuously available to a user, regardless of ambient light level. It is also desirable for the display to consume as little power as possible to prolong the life of the battery. To make information readily available, it is helpful if the display is not restricted in location by the form of the system of which it is a part; that is, function is largely independent of form.

In view of the foregoing, it is therefore an object of the invention to simplify the content of a display by moving some information to a secondary display.

Another object of the invention is to provide a display that is readable under all lighting conditions.

A further object of the invention is to provide a secondary display of low information content that can be located optimally in a system, independently of high information content displays.

Another object of the invention is to provide a secondary display of low information content that can be located optimally in a system, independently of the form of the system.

A further object of the invention is to provide a secondary display that can be operated continuously.

### SUMMARY OF THE INVENTION

The foregoing objects are achieved by the invention in which a secondary display is provided on, in, or under the case of an electronic device at a location convenient for viewing. The secondary display includes PDLC and a backlight. The backlight is preferably either an electroluminescent panel or an array of light emitting die. In the latter case, a transflector is located between the light source and the PDLC.

### BRIEF DESCRIPTION OF THE DRAWINGS

A more complete understanding of the invention can be obtained by considering the following detailed description in conjunction with the accompanying drawings, in which:

FIG. 1 is a perspective view of a cellular telephone incorporating secondary displays in accordance with the invention;

FIG. 2 is a front view of a folding cellular telephone incorporating secondary displays in accordance with the invention;

FIG. 3 is a front view of an unfolded cellular telephone incorporating secondary displays in accordance with the invention;

FIG. 4 is a plan view of an instrument panel incorporating secondary displays in accordance with the invention;

FIG. 5 is a perspective view of a lap top computer incorporating secondary displays in accordance with the invention;

FIG. 6 is a cross-section of a polymer dispersed liquid crystal display constructed as known in the art;

FIG. 7 is a cross-section of a thick film, electroluminescent lamp constructed as known in the art;

FIG. 8 is a perspective view of an array of light emitting die constructed as known in the art;

FIG. 9 is a cross-section of the case of an electronic device incorporating a secondary display in accordance with one aspect of the invention;

FIG. 10 is a cross-section of the case of an electronic device incorporating a secondary display in accordance with another aspect of the invention;

FIG. 11 is a cross-section of the case of an electronic device incorporating a secondary display in accordance with another aspect of the invention;

FIG. 12 is a cross-section of the case of an electronic device incorporating a secondary display in accordance with another aspect of the invention;

FIG. 13 is a cross-section of an edge lit light guide for back lighting a display; and

FIG. 14 is a cross-section of a light guide including optical fibers for back lighting a display.

### DETAILED DESCRIPTION OF THE INVENTION

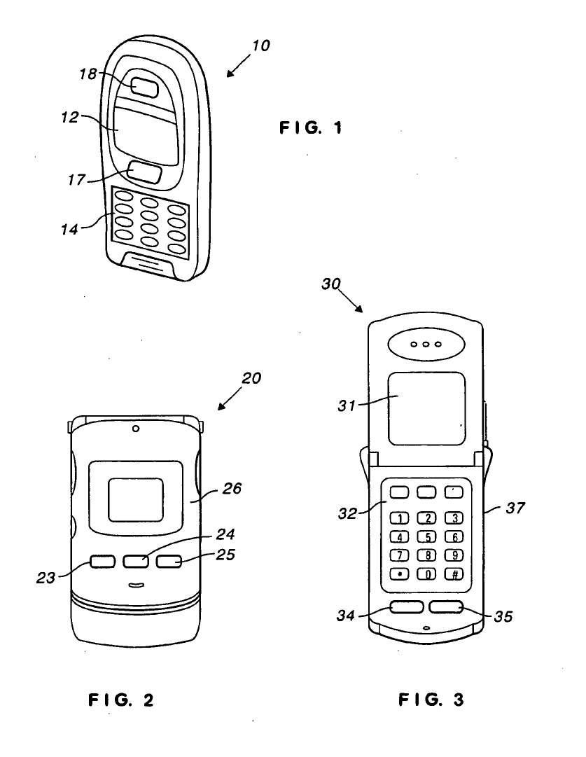

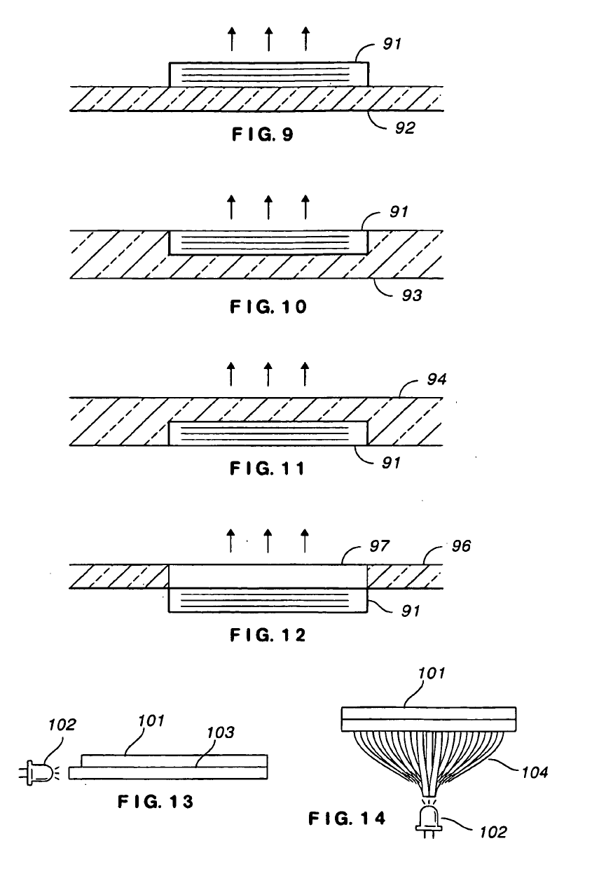

FIG. 1 is a perspective view of a cellular telephone, meant to also represent any personal electronic device that does not open or unfold in some way. Telephone 10 includes display 12 where the information typically associated with telephones is displayed. In addition, and not part of display 12 or keypad 14, are secondary displays 17 and 18. In accordance with the invention, these displays are used for low content information, such as signal strength, battery life, or roaming. The number of secondary displays is a matter of design, depending, in part, on the nature of the particular portable electronic device. As described in connection with FIGS. 9-12, the displays can be form on, in, or under the case of telephone 10.

FIG. 2 is a front view of a folding cellular telephone incorporating secondary displays in accordance with the invention and represents any portable electronic device having a folding structure. Telephone 20 includes secondary displays 17 and 18 formed on, in or under shell 26. As with the embodiment of FIG. 1, these displays are used for low content information, such as signal strength, battery life, incoming call, or roaming. The number of secondary displays is a matter of design, depending, in part, on the nature of a particular telephone.

FIG. 3 is a front view of an unfolded cellular telephone incorporating secondary displays in accordance with the invention and represents any portable electronic device that unfolds for operation. Telephone 30 includes primary display 31 and keypad 32. Telephone 30 also includes secondary displays 34 and 35 formed on, in or under lower case portion 37. As with the other embodiments, these displays are not part of a keypad and are used for low content information, such as signal strength, battery life, incoming call, or roaming. The number of secondary displays is a matter of design, depending, in part, on the nature of the particular telephone.

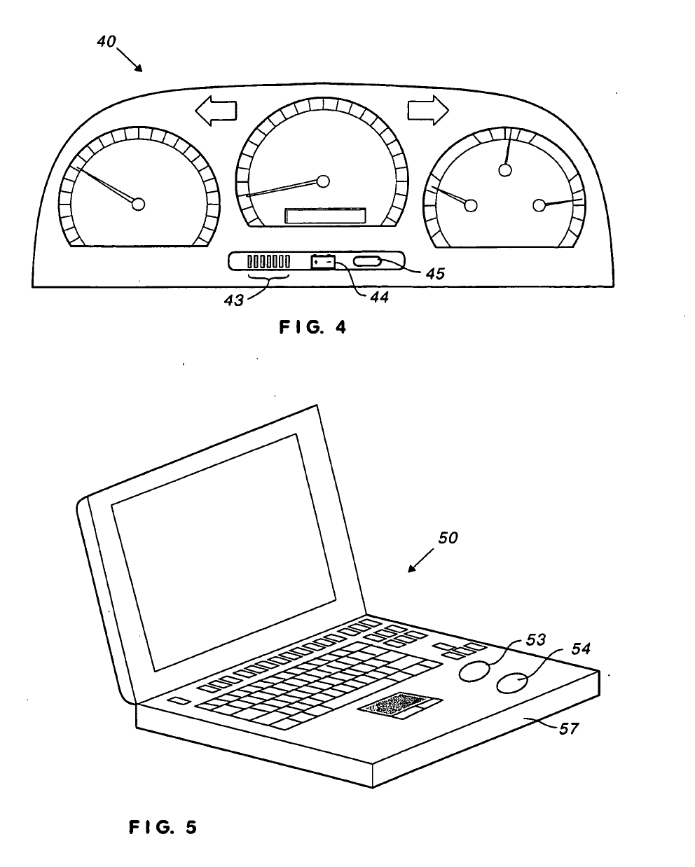

FIG. 4 is a plan view of an instrument panel incorporating secondary displays in accordance with the invention. The instrument panel could be used in any type of vehicle such as automobile, aircraft, motorcycle, or heavy equipment. Instrument panel 40 includes gauges and displays appropriate for the particular application. In accordance with the invention, instrument panel 40 includes secondary displays 43, 44, and 45 formed on, in or under the panel. These displays provide low content information, such as heading, operating hours, battery condition, or status of a safety device. The number of secondary displays is a matter of design, depending, in part, on the nature of the vehicle.

FIG. 5 is a perspective view of a lap top computer incorporating secondary displays in accordance with the invention. In accordance with the invention, computer 50 includes secondary displays 53, and 54 formed on, in or under case 57. These displays provide low content information, such as detecting a wireless network or battery condition. The number of secondary displays is a matter of design, depending, in part, on the nature of the portable computer. One or more secondary displays could be located on the outside of computer 50, as in the embodiment of FIG. 2.

FIG. 6 is a cross-section of a polymer dispersed liquid crystal display constructed as known in the art. Display 60 includes PDLC device 61 overlying light source 63. Light source 63 is preferably either an electroluminescent panel or light emitting diodes coupled to a light guide. If the latter are used, transflective layer 65 is added between light source 63 and PDLC device 61. If an electroluminescent panel is used, a transflective layer is not necessary because the panel is sufficiently reflective. In most environments for work or recreational activity, the light level is sufficient to read display 60. If not, light source 63 is turned on to backlight device 61.

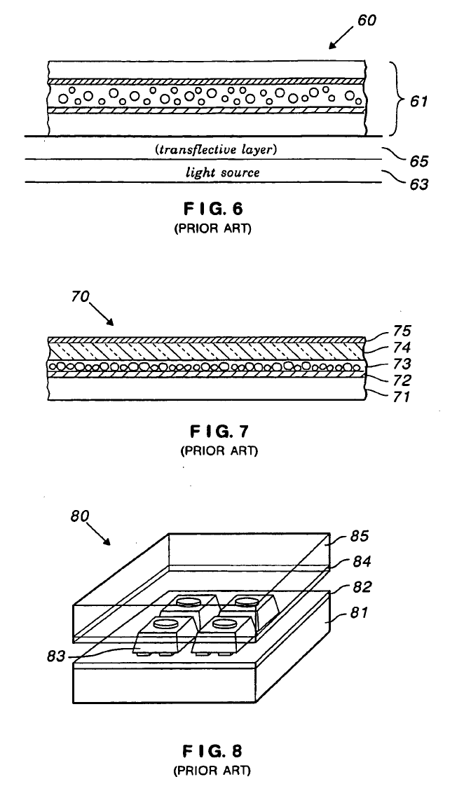

FIG. 7 is a cross-section of a thick film, electroluminescent lamp constructed as known in the art. In FIG. 7, transparent front electrode 72 overlies transparent substrate 71 and is a thin layer of indium tin oxide or indium oxide. Phosphor layer 73 overlies the front electrode and dielectric layer 74 overlies the phosphor layer. Layers 73 and 74 are combined in some applications. Overlying dielectric layer 74 is opaque rear electrode 75. An optional backing layer (not shown) may also be provided, e.g. for insulating the rear electrode. Coated phosphor particles are used, eliminating the need for a sealing layer. The phosphor layer, or an additional layer, may contain additives for color correction, to assure that the color of the light reflected when the lamp is off is close to the color of the light emitted by the lamp when turned on.

In portable electronic devices, an EL lamp is powered by a driver that converts low voltage direct current from a battery into high voltage alternating current. In order for an EL lamp to glow sufficiently, a peak-to-peak voltage in excess of about one hundred volts is necessary. This is the same voltage necessary for operating a PDLC display. This enables one to use the same driver for both devices, simplifying construction and lowering costs.

FIG. 8 is a perspective view of an array of light emitting die constructed as known in the art. In FIG. 8, electrode 82 overlies transparent substrate 81. An array of light emitting semiconductor die, including die 83, overlies electrode 82. Transparent conductive layer 84 is in contact with the upper, light emitting faces of the die in the array. Layer 84 is formed on transparent substrate 85. Although appearing somewhat thick as shown in FIG. 8, the drawing is not to scale. The assembled array is sufficiently thin for use in cellular telephones and other devices where thickness is a consideration.

As noted above, the secondary display can be formed on, in, or under the case of the electronic device to which it is coupled. The arrows in FIGS. 9-12 indicate light emission and the outside of the case or the surface facing the user. In FIG. 9, secondary display 91 is formed on case 92 and coupled to control electronics (not shown) through conductors (not shown) molded into the case. In FIG. 10, secondary display 91 is molded into case 93, for example as described in U.S. Pat. No. 5,565,733 (Krafcik et al.) or as described in application Ser. No. 10/674,275, filed Sep. 29, 2003, entitled Flexible, Molded EL Lamp, and assigned to the assignee of this invention. The contents of the application are incorporated herein by reference.

In FIG. 11, secondary display 91 is molded into the lower surface case 94, which is transparent, at least in the area of secondary display 91. In FIG. 12, secondary display 91 is formed on the inner surface of case 96 and light is coupled through window 97 to the user. Case 96 could be transparent or translucent instead.

FIG. 13 is a cross-section of a back lit display. Specifically, display 101 is back lit by one or more light emitting diodes, such as light emitting diode 102, coupled to light guide 103. Light guide 103 spreads the light emitted by light emitting diode 102 for back lighting the lower surface of display 101.

In FIG. 14, light from one or more light emitting diodes, such as light emitting diode 102, is spread by a light guide including a plurality of optical fibers 104 for back lighting display 101.

The invention thus simplifies the content of a primary display by moving some information to a secondary display. The invention provides a display that is readable under all lighting conditions and that can be operated continuously. The secondary display can be located optimally in a system, independently of high information content displays and the form, shape, or configuration of a system.

Having thus described the invention, it will be apparent to those of skill in the art that various modifications can be made within the scope of the invention. For example, although illustrated as a 2×2 array, the diode array can be linear (1×n) or any number of die in a pattern to produce sufficiently uniform light, e.g. radially place die. The diode array can include packaged rather than unpackaged die.

What is claimed is:

1. In an electronic device having a display, the improvement comprising:
a secondary display at a location convenient for viewing, said secondary display including PDLC and a backlight.

2. The electronic device as set forth in claim 1 wherein said backlight is an electroluminescent panel.

3. The electronic device as set forth in claim 1 wherein said backlight is an array of light emitting die.

4. The electronic device as set forth in claim 1 wherein said backlight includes at least one light emitting diode and a light guide for spreading the light from the at least one light emitting diode.

5. The electronic device as set forth in claim 4 wherein said light guide is an edge lit light conducting sheet.

6. The electronic device as set forth in claim 4 wherein said light guide includes a plurality of optical fibers.

5. The electronic device as set forth in claim 4 and further including a transflective layer located between the backlight and the PDLC.

6. The electronic device as set forth in claim 1 wherein said secondary display contains low content information.

7. The electronic device as set forth in claim 1 wherein the electronic device is a portable computer and said location is visible on an outer surface of the computer.

8. The electronic device as set forth in claim 1 wherein the electronic device is a cellular telephone.

9. The electronic device as set forth in claim 1 wherein the electronic device is an instrument panel.
